(19) United States
(12) Patent Application Publication
(10) Pub. No.: US 2022/0325374 A1
(43) Pub. Date: Oct. 13, 2022

(54) GANGUE REJECTION FROM ORES

(71) Applicant: Anglo American Technical & Sustainability Services Ltd, London (GB)

(72) Inventors: Anthony Owen FILMER, Kangaroo Point (AU); Daniel John ALEXANDER, London (GB)

(21) Appl. No.: 17/840,705

(22) Filed: Jun. 15, 2022

Related U.S. Application Data
(63) Continuation of application No. PCT/IB2020/061677, filed on Dec. 9, 2020.
(60) Provisional application No. 62/950,321, filed on Dec. 19, 2019.

(51) Int. Cl. C22B 1/24

(52) U.S. Cl. CPC C22B 1/24

(57) ABSTRACT

A process for recovering value metals from ore comprising rock, including the steps of preselection of a grade of ore to be microwaved to form an ore stream; subjecting the ore stream to microwave energy to partially fracture rocks in the stream and form a partially fractured ore stream; crushing the partially fractured ore stream to preferentially fracture the pre-weakened ore, to form a crushed ore stream; and Screening the crushed ore stream to form a fines fraction ore stream for further processing; and a gangue fraction that may justify further processing.

This application is a continuation of International Application No. PCT/IB2020/061677, filed Dec. 9, 2020, entitled “Gangue Rejection from Ores”, which claims priority to and the benefit of U.S. Provisional Patent Application No. 62/950,321, filed Dec. 19, 2019, entitled “Gangue Rejection from Ores”, the disclosures of which are incorporated herein by reference in their entireties.

### BACKGROUND OF THE INVENTION

The ability to reject dry coarse gangue (commercially valueless material in which valuable minerals are found), either as rock or sand, provides the mining industry with multiple benefits including reduced energy and equipment required for comminution, higher grades for processing to recover the values from the ore, ability to form stable landforms from the waste, and a reduced consumption of water.

The natural deportment of minerals to the finer fractions that are formed during blasting, crushing and grinding, is well known. Fracture tends to occur along mineralised grain boundaries, resulting in this differential deportment.

CRC Ore (https://www.crcore.org.au/images/CRC-ORE/papers/Walters-S-2016-Grade-Engineering-Whitepaper.pdf) have characterized thousands of ore samples across multiple mineral commodities and established the characteristic of differential deportment with size across multiple commodities, and different ore types.

The differential deportment to the fines is described in terms of a response factor. The response factor is defined as the grade of the undersize product divided by the grade of the feed, for any particular mass pull. This analysis has been carried out by CRC Ore for a large number of different ores a few of which are shown in FIG. 1.

FIG. 1 is an example of response factor curves versus retained mass for laboratory testing of preferential grade by size response using crushed drill cores. Plain solid lines indicate mathematical response rankings.

Data points shown in FIG. 1 represent actual test laboratory results for preferential grade deportment by size using crushed drill cores at a range of mesh sizes (Carrasco et al. 2014). The effect of varying mass retained on response factor is evident. The resulting family of cumulative distributions can be described using a mathematical function irrespective of mass pull, shown in the plain solid lines.

A high response factor corresponds with a high upgrade of the screen undersize product, and a low-grade of the oversize screen reject. For this particular set of ores, if the screen size is set to reject 50% of the mass, the grade of the product will increase around 5% for the worst performing ore sample, and 50% for the best performing ore sample.

Screening of blasted or crushed ore, as studied by CRC Ore, has often been suggested as a method of upgrading what is currently considered waste rock into ore. It has also been suggested for increasing production by generating a higher-grade undersize fraction and stockpiling a lower grade oversize ore for later treatment.

Despite this near universal differential deportment being well established for several decades, the commercial application of the screening technique is limited to a handful of applications.

The reasons for this lack of commercial uptake is the modest response factor (the extent to which ore grade can be increased without discarding excessive ore) that is achievable by screening, combined with the variability of the response factor across different ore types.

The modest response factor implies that the fraction of gangue (rock that still contains some of the valuable mineral, but the grade is too low to warrant further comminution and processing) that can be rejected from the ore is insufficient to justify the additional mining and processing costs.

Even where the response factor is high and reasonably consistent across the different ore types in the deposit, the ore grade varies within the mine. Thus, for a low-grade patch of ore, a given screen size may generate a disposable gangue, but for the high-grade zone, the grade of the same screen oversize component will still represent a valuable ore.

As examples, if only a few percent of the ore can be rejected as gangue, it is simply not worth the cost of materials handling to reject this modest fraction. If only a particular type of ore within an overall orebody yields good response, it is simply not worth the complexity of segregation and intermittent operation to screen this particular geological domain.

Various methods have been utilised to address the modest upgrade factors achievable by screening.

For those operations that are amenable to heap leaching of the gangue, the consequences of misplaced ore are reduced, and hence a larger fraction of ore can be rejected by screening and then assigned to heap leach.

Separately, the ability of microwave energy to weaken ores prior to crushing and grinding has also been well established. (https://www.tandfonline.com/doi/abs/10.1080/08327823.2005.11688544)

Through irradiating the ore with microwave energy, the mineralised components of ore absorb the microwave energy whilst the gangue minerals are transparent. This causes differential heating within the rocks (ore), causing thermal expansion and localized stress at the grain boundaries between the thermally expanding mineralised components and transparent minerals.

With sufficient irradiation the induced stress can cause the rock to split.

But in more normal applications, it is usual for the microwaves to cause microfractures, which when the irradiated rock is subsequently crushed and ground, reduces the total energy required for comminution and increases mineral liberation and hence recovery during flotation or leaching.

This use of microwaves for enhancing recoveries of values during heap leaching has been claimed by Batterham et. al. (CA2487743). In this publication the potential for heap leaching or subsequent comminution and physical separation of the microwaved particles is recognized. However, Batterham contains no teaching on preselecting the ore for microwaving on the basis of grade. Nor does it contain any teaching on the comminution techniques to prepare the microwaved ore fractions for subsequent discard or processing, nor on the subsequent processing to discard coarse gangue prior to full comminution.

Despite the many demonstrated results of enhanced energy efficiency and subsequent flotation and leaching recovery after microwaving, the commercial use of microwave energy has been limited.

This is assumed to be due to the difficulties in scaling up the microwave application equipment to the size and robustness required for a typical large-scale copper or gold processing operation.

It is an object of the present invention to provide a process which an ore can be processed, to enable a high level of gangue rejection by separation utilising particle size, which gangue can be finally rejected or further processed.

### SUMMARY OF THE INVENTION

This invention relates to a process for recovering value metals from ore comprising rock, including the steps of:
i. preselection of a grade of ore to be subject to microwave energy to form an ore stream;
ii. subjecting the ore stream to microwave energy to partially fracture rocks in the ore stream and form a partially fractured ore stream;
iii. crushing the partially fractured ore stream to preferentially fracture the pre-weakened ore, to form a crushed ore stream; and
iv. Screening or otherwise classifying the crushed ore stream to form:
a fines fraction ore stream for further processing; and
a gangue fraction that may be subject to further processing.

The preselection at step i may be undertaken using:
bulk sorting to allocate a preferred range of ore grades from the run of mine (RoM) ore to the ore stream to be microwaved; or
screening or other form of size related classification to allocate the preferred range of ore sizes or grade for microwave treatment, For example a copper ore of greater than 10 mm or a gold ore containing less than 1 gpt (grams per ton) gold from the run of mine ore, could be assigned to the ore stream to be microwaved.

Similarly, the preselection step i may include a Coarse Particle Flotation (CPF) step to allocate a coarse particle flotation residue with minimal surface exposure of values to the ore stream to be microwaved.

Typically, the product from microwaving and crushing (the crushed ore stream) results in exposure of values at a much coarser particle size, enabling high recoveries in subsequent coarse particle flotation at a coarser particle size.

In one possible embodiment of the invention, in step i, the ore stream may be classified into the following streams:
particle size of less than 0.15 mm for conventional flotation,
particle size from 0.15-0.4 mm for coarse particle flotation,
particle size from 0.4-2 mm for very coarse particle flotation, and
particle size greater than 2 mm is recycled to the crusher, wherein:
a residue from the very coarse particle flotation and the particle size greater than 2 mm are subjected to the microwave energy in step ii, crushing step iii, and further classifying step iv.

Process parameters of microwave power, crushing energy and screen size may be selected to produce a screen oversize (gangue fraction) from step iv, that is suited for direct disposal or processing by heap leaching.

Process parameters of microwave power, crushing energy and screen size may be selected to produce a screen oversize (gangue fraction) from step iv that is suited for heap leaching.

Process parameters of microwave power, crushing energy and screen size may be selected to produce a screen oversize (gangue fraction) from step iv that is suited for stockpiling and processing later in the mine life.

Preferably, the natural deportment response factor after microwaving and crushing, as measured at 50% mass retention, has been increased by more than 10% and preferably more than 20% and even more preferably more than 30%, relative to the response factor of the untreated ore.

The steps of preselection, microwaving, crushing and screening is preferably carried out with RoM ore without addition of water, to produce a dry gangue fraction at step iv.

The step of preselection may select more than one fraction for microwaving crushing and screening, and the process parameters for each step on each feed fraction may be selected according to the feed grade.

Furthermore, the material in both the rejected gangue fraction and the higher-grade fraction. generated subsequent to the microwave processing, contain more selective fracturing along the grain boundaries of the values contained in the ore. This enhanced liberation of values makes both fractions more amenable to high recoveries in their subsequent processing, by heap leach or by flotation.

As such, the pre-selection of an ore fraction for microwaving delivers a dual benefit. For example, an ore that is marginal grade for assignment to either flotation or heap leach, is not only more readily crushed to the ideal size for optimising the allocation to whichever processing route which delivers the highest financial margin, but also delivers higher extraction in both processes.

As a second example, an ore that is marginal grade for assignment to either processing or waste, is not only more readily crushed to the ideal size for optimising the grade and recovery to processing, but also delivers higher extraction in the processing.

The term “microwave energy” is understood herein to mean electromagnetic radiation that has frequencies in the range of 0.3-300 GHz.

Preferably step (ii) includes using pulsed microwave energy.

More preferably step (ii) includes using pulsed high energy microwave energy.

The term “high energy” is understood herein to mean values substantially above those within conventional household microwaves, i.e. substantially above 1 kW.

Preferably the energy of the microwave energy is at least 20 kW.

More preferably the energy of the microwave energy is at least 50 kW.

The use of microwave energy in step (ii) may be as described in International publication numbers WO03/102250 and WO 06/034553, the disclosure of which is incorporated herein by reference.

The use of pulsed microwave energy minimises the power requirements of the method and maximises thermal cycling of the ore particles. Preferably the pulsed microwave energy includes pulses of short duration.

The term “short duration” is understood herein to mean that the time period of each pulse is less than 1 second.

Preferably the pulse time period is less than 0.1 second.

The pulse time period may be less than 0.01 second.

More preferably the pulse time period is less than 0.001 second.

The time period between pulses of microwave energy may be set as required depending on a number of factors as hereinbefore described.

Preferably the time period between pulses is 10-20 times the pulse time period.

The ore stream may be exposed to one or more pulses of microwaves. This can be achieved in a single installation which releases microwave energy in pulses. This can also be achieved in an installation having multiple exposure points at spaced intervals along a path of movement of the ore stream, with each of the exposure points releasing its own characteristic microwave energy in pulses or continuously.

The wavelength of the microwave energy and the exposure time may be selected depending on relevant factors as hereinbefore described.

Relevant factors may include ore type, particle size, particle size distribution, and requirements for subsequent processing of the ore.

The process according to the present invention includes any suitable steps for exposing mined ore to microwave energy.

One suitable option includes allowing mined ore to free-fall down a transfer chute past a microwave energy generator, such as described in International publication number WO 03/102250.

The free-fall option is one preferred option in a mining industry environment because of the materials handling issues that are often associated with the mining industry.

Another option is to pass the ore through a microwave cavity on a moving bed, preferably a mixed moving bed, with a microwave generator positioned to expose the ore stream to microwave energy such as described in International publication number WO 06/034553.

The term “moving mixed bed” is understood to mean a bed that mixes ore particles as the particles move through a microwave exposure zone or zones and thereby changes positions of particles with respect to other particles and to the incident microwave energy as the particles move through the zone or zones.

### BRIEF DESCRIPTION OF THE DRAWINGS

FIG. 1 is a graph showing the differential deportment of the valuable component of the ore to the fines for different ore samples;

FIG. 2 is a block flowsheet of a basic embodiment of the invention of a process utilising Microwaves to Increase Coarse Gangue Rejection;

FIG. 3 is a block flowsheet of a first embodiment of the invention designed to maximise resource recovery from a given ore resource;

FIG. 4 is a block flowsheet of a second embodiment of the invention designed to enhance production by feeding higher grade ore to processing;

FIG. 5 is a block flowsheet of a third embodiment of the invention designed to achieve the desired increase in grade by prescreening the ore;

FIG. 6 is a block flowsheet of a fourth embodiment of the invention designed to microwave only the sand which has not achieved sufficient exposure during normal comminution, to have been recovered by coarse particle flotation; and

FIG. 7 is a block flowsheet of a fourth embodiment of the invention designed to prepare the ore for heap leaching.

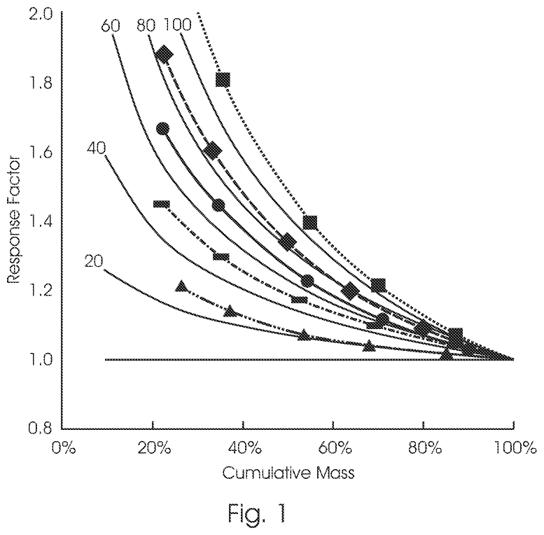

### DESCRIPTION OF PREFERRED EMBODIMENTS

The current invention provides for a process of combining the technologies of crushing, screening and microwaving into a system which
preselects the ore to utilise the available microwave capacity with the ore where microwaves deliver the greatest benefits,
enables a larger fraction of coarse gangue to be rejected by screening, to significantly increase the grade of the ore proceeding to further processing.

Microwaves cause microfractures along mineralised grain boundaries to provide zones of weakness within rocks. These mineral specific weakness zones can be utilised under the appropriate comminution conditions to cause differential fracture, to cause more of the values to report to the finer fraction of the ore. By selecting the crushing method and appropriate screen size relative to the feed, a high response factor can be achieved.

The invention can be applied to any ores where differential absorption of microwaves occurs between the mineral of interest, and the surrounding gangue. As non-exclusive examples, this includes base metal sulphides, gold, platinum group metals, and diamond containing ores.

Since the use of microwaves is somewhat limited by scale of throughput through the microwave irradiation reactor, it is advantageous to preselect the ore fraction to be processed through the microwave, to that ore which benefits substantially from the treatment.

This pre-selection is the first component that differentiates the current invention from the known application of microwaves to reduce crushing energy and enhance leachability or flotation recovery.

Ideally, the pre-selected ore will be those particles in which fracture and subsequent beneficiation recoveries cause issues in conventional comminution and processing technologies. This corresponds to the fraction of the mined ore in which either physical access to the mineral is particularly difficult or where the comminution and processing costs are particularly high, per unit of extra metal recovered.

This typically corresponds to the fraction of ore where the uplift in the grade arising from applying microwaves and differential crushing, is greatest.

Using the current invention, the dual benefits of high overall recovery of values, and the benefits of increased coarse gangue rejection, can be achieved simultaneously, or can be weighted to favour either increased gangue rejection or increased recovery.

Effectively the system can be used for dry beneficiation of ores, leaving a high-grade stream of ore for processing by whichever processing technology is most appropriate

The pre-selection of the fraction to feed the microwave will be specific to each ore, depending on grade, the rock or sand size, the natural response factors, and mineralogy; and the costs and recoveries in the subsequent processing technologies; such as the comminution, flotation and leaching.

Depending on the particular ore, the pre-selection is undertaken on the basis of one or more of particle size, ore grade, ore type, or surface exposure of the mineralised value.

The crushing is the second component of the current invention which differentiates it from previous known methods of utilising microwaves.

The microwaving of the ore creates the ability to differentially fracture the ore. In an idealized system, the subsequent crushing should fracture the ore along every microcrack, but not break any of the unfractured gangue, allowing a very effective separation during subsequent screening. i.e. a very high response factor. Ideally, the invention guides the selection of the comminution device and the energy imparted in that device, to suit the characteristics of the particular ore.

In general, the fracture selectivity on crushing will be greatest for mild unconstrained point loads applied by the crusher to the microfractured rock. Excessive and/or constrained impact forces will also fracture the gangue particles. This principle favours dry impact crushers such as a vertical shaft impactor (VSI), Energy Densification System (EDS) and Vero liberator mills, (described in US2016228879, the content of which is incorporated herein by reference) relative to compressive fracture such as occurs in an HPGR (high pressure grinding rolls), relative to the more abrasive fracture such as occurs in a semi-autogenous grinding (SAG) mill. But depending on the circumstances, all crushing systems can be utilised either in isolation or combination, by adjusting the energy input to optimise the differential sizing and hence the quantity of gangue rejected.

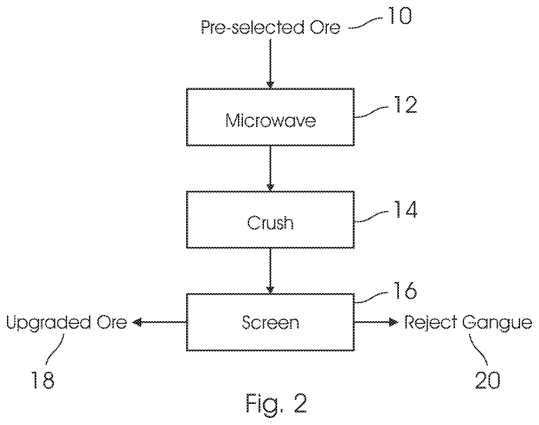

The core of the current invention is described in FIG. 2 and consists of
Pre-selecting the ore to that suited for microwave processing 10,
Exposing this pre-selected ore to microwaves (microwave energy) 12 to partially fracture the ore,
Comminuting the ore 14 to achieve selective fracture with enhanced deportment by size, and
Classifying the ore 16 based on size, into
a high-grade fraction 18 for further processing
   and a gangue fraction 20 which may be rejected, or stockpiled, or heap leached.

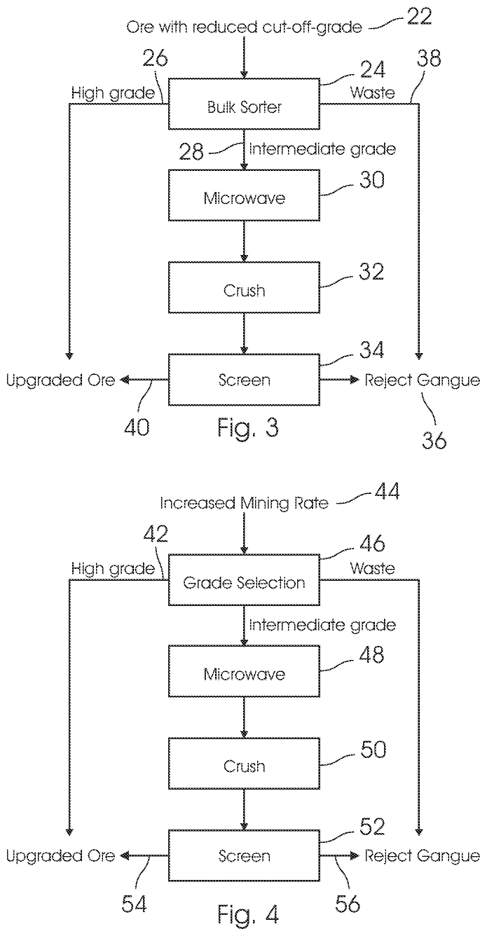

FIG. 3 shows a process of a first embodiment of the invention designed to maximise resource recovery from a given ore resource. Ore 22 is separated by grade control procedures and a bulk sorter 24 and potentially bulk sorting into two or more streams, selected on the basis of grade. The higher-grade stream 26 is blended with the upgraded ore 40 from the screening process 34 and is assigned directly to the conventional comminution (further processing.

In bulk sorting, ore that has been fragmented by blasting, is typically transported by truck or conveyor to a primary crusher, and by conveyor to grinding. On the conveyor either before or after the primary crusher, the grade of the ore (or deleterious contaminants) can be analysed, using techniques such as prompt gamma neutron activation analysis, for example an on-conveyor PGNAA Analyser as supplied by several suppliers, for example a cross belt analyser available from SODERN, which makes use of an electrical neutron source with stabilised emission http://www.sodern.com/sites/en/ref/Cross-belt-Analyser_71.html, PGNAA is a nuclear process used for determining the concentrations of elements averaged across a bulk amount of materials, thus allowing a decision to divert the stream of rock to ore or to waste.

The intermediate grade stream or stream(s) 28 are prepared for feeding the microwave application equipment 30 and microwaved to create fractures within the rocks. The partially fractured rock is then crushed 32 further in a selective controlled energy crushing device, to cause fracture along the pre-existing microfractures.

The fractured ores are then screened 34 in the coarse fraction containing predominantly gangue is rejected, either to waste 36 (together with waste 38 from the grade control 24), or to heap leach, or to a low-grade stockpile. The higher grade fraction 40 is suitable for further processing.

The system is optimised for a particular ore resource through selection of initial cut-off-grade of ore, the level of irradiation by microwaves, the type and energy input for crushing, and the screen sizes selected to separate the ore.

Because the low-grade reject stream 36 has no comminution costs, the cut-off-grade for ore selected for microwaving 28 can be reduced relative to the higher cost conventional comminution and processing, thus enabling higher overall values recovery from the mined resource 22.

The microwave intensity is selected for the particular ore, to achieve a high degree of cracking along grain boundaries of the mineralised values, thus enhancing the differential fracture during subsequent crushing.

The crusher type and energy input are selected to promote selective fracture along the pre-existing cracks caused by the microwaves, by reducing the point loads that individual rocks experience, to more selectively break pre-fractured rocks.

The screen size for the optimum separation can be selected to generate the grade in the gangue fraction suitable for rejection.

Where the pretreatment has selected more than one low grade stream, for example a very low grade and an intermediate stream, the microwave intensity, crushing energy and screen size can be set differently to enable optimum gangue rejection efficiency for both streams.

Similar differential settings would be utilised if the pre-selected streams were divided on the basis of ore mineralogy. As examples, the ore could be pre-selected into primary and secondary ore fractions where the secondary copper ore is readily heap leached; or where one ore domain exhibited a much higher response factor with natural deportment of values to the fine fraction.

As one typical application of the invention, assume the cut-off-grade (CoG) of a typical conventional copper mine is 0.3% Cu by weight. Conventionally, all ore below 0.3% Cu, as measured by grade control processes, would be assigned directly to waste. As a proportion of total mined material, the material containing between 0.2 and 0.3% Cu represents around 10% of the total copper mined in an open pit mine. Utilising the invention, the CoG for mining and processing the ore would be reduced to around 0.2% Cu. When the ore between 0.2-0.4% Cu is preselected by bulk sorting, it represents around 30% of the new total mass of run of mine (RoM) ore. Through application of the current invention this stream will yield a product containing around 50% by weight of 0.45% Cu ore and 50% by weight of a reject stream containing around 0.15% Cu. Thus, much of the copper has been recovered from ore that is just below CoG, with a higher copper yield from mined ore of around 5%.

And since some of the gangue that was consuming space in the conventional processing assets has been rejected prior to conventional processing. The overall grade of the ore proceeding to conventional processing has increased by around 5%, reducing total comminution costs per tonne of Cu by 5%.

These gains from the current invention are additional to any benefit that might be provided by microwaves in subsequent comminution, and flotation or leach recoveries. Such as claimed in CA2487743, the content of which is incorporated herein by reference.

Whilst not limited, this configuration of the invention is particularly attractive for mines with a limited amount of mineral resource available, where the life of mine can be extended without the cost implications associated with grinding very low-grade ore.

FIG. 4 shows a process of a second embodiment of the invention designed to enhance production by feeding higher grade ore to processing.

Most open pit copper and gold mines are designed such that their bottleneck is the grinding operation to prepare the ore for flotation or leaching. In this second embodiment, the invention is utilised to reject a higher proportion of the gangue than in the first embodiment, thus leaving a higher grade of ore to proceed to conventional processing, where the increased grade of ore feeding the mills represents increased production.

Relative to the first embodiment, a higher cut-off-grade (CoG) 42 of the RoM 44 is selected by grade control or bulk sorting 46. This results in microwaving 48 a higher grade of ore, albeit that the fraction microwaved is the lower (intermediate) grade available from grade selection.

The operating conditions used in the configuration typically promote extensive cracking during microwave process, to promote the size-based deportment differential after crushing 50, and crushing with lower energy input to avoid fracture of the predominance of the gangue, and finally by selecting a smaller screen size 52 to capture the high-grade feed 54 for conventional processing.

The reject gangue 56 in this particular configuration is a slightly higher grade and hence is more likely to be stockpiled for processing later in the mine life, or heap leached.

In an example of a typical application of the configuration to enhance total production, mining rate is increased by say 20%, with the same CoG of 0.7 gpt Au. Then 40% of this expanded RoM ore, with the lowest grade is preselected using normal grade control techniques or bulk sorting. The preselected ore having a grade of around 1 gpt Au is microwaved, crushed and screened to produce 20% of the total ore in the high-grade stream, and 20% of the ore as reject. The high-grade stream from screening rejoins the high-grade stream from grade control processes, with the grade of the screened ore having been enhanced from 1 gpt Au to 1.6 gpt. The overall gold grade being milled, and overall gold production is enhanced. The oversize reject from screening contains 0.5 gpt Au and is assigned to waste or heap leach.

Whilst not limited, this embodiment is particularly attractive for a large low grade resource, where the grade does not warrant fine grinding of the low-grade material.

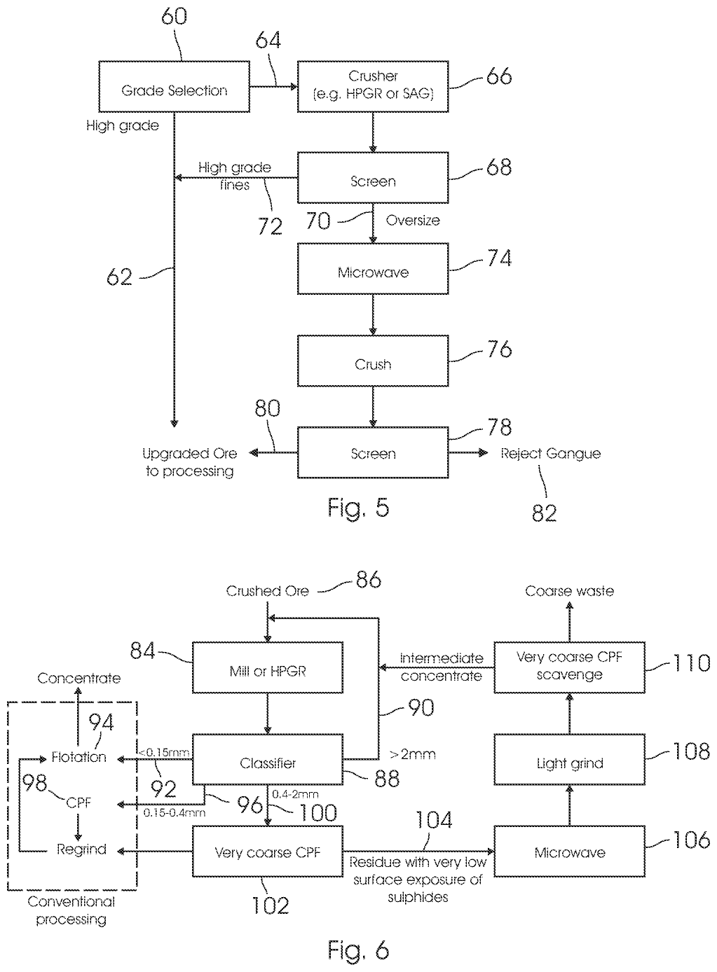

FIG. 5 illustrates a third embodiment of the invention designed to achieve the desired grade by prescreening the ore where liberation of values is naturally problematic. RoM is selected by grade control or bulk sorting 60 to provide a high-grade stream 62 and an intermediate grade stream 64 which is crushed 66 and screened 68. Based on the natural deportment of values to the fines, the screen size is selected to generate a lower grade fraction 70 suited to microwaving, and a high grade fraction 72. This has a co-benefit of microwaving only the rocks or sand which are more difficult to fracture in conventional crushing equipment. The lower grade fraction 70 is subjected to microwave irradiation 74, and sent for crushing 76. After crushing 76, and crushing with lower energy input to avoid fracture of the predominance of the gangue, and finally by selecting a smaller screen size 78 to capture the high-grade feed 80 for conventional processing, and a reject gangue 82.

If the constraint to the operation is designed to be the throughput of the microwave irradiation, it is appropriate to only process ore which will not fracture readily in conventional comminution.

Those rocks or sand which have not previously been fractured during blasting and comminution are selected by screening 68, thus isolating the oversize ore fraction which has already exhibited greater inherent strength along the grain boundaries.

One example of size based selection is the pebbles of a several cm diameter, generated during SAG crushing, where the very hard parcels of ore do not fracture at acceptable rates, despite some of the parcels containing significant metal values.

A second example is the oversize of a few cm diameter generated during HPGR crushing prior to coarse flotation. In this case, compressive fracturing has not already caused the contained values to deport to the fine fraction. This concept of selecting the microwave feed of the appropriate grade on the basis of size, can be extended from rock size further down the size range into the sub 1 mm separation size, when applied to the products of tertiary crushing and even grinding.

A third example is simply pre-screening of the ore resulting from blasting and primary crushing, to screen at a size which preselects the grade of the harder ore which has not fractured during previous stresses. This more difficult fraction of the RoM can then be assigned to the optimum treatment through microwaves, crushing and screening to reject additional gangue.

As an example of the application of this configuration, when using a SAG mill for crushing and grinding a 0.7% copper ore, the pebbles which accumulate have a typical average grade of around 0.3% copper. Conventionally, this pebble grade is too high to discard, and hence the hard pebbles are removed from the SAG mill, crushed and reintroduced to the comminution circuit. Through the use of the current invention, the pebbles can be microwaved, lightly crushed and screened prior to reintroduction. The fines from screening will have a copper grade similar to the RoM, and about 30% of the oversize will be below the grade suitable for further comminution, and hence ready for discharge. For a relatively modest microwave throughput, the grade of ore in milling and the mill capacity is increased.

As a second example of the application of this configuration, a copper ore grading 0.7% Cu is crushed in a secondary crusher to a p80 of around 20 mm (being the screen size through which 80% of the particles will pass). and screened to remove all the ore that is of a size suitable for coarse flotation and conventional, typically less than 0.5 mm. The oversize is subjected to microwave treatment, and then lightly crushed in a tertiary crusher to a p80 of around 10 mm, and again screened to remove the size fraction suitable for coarse flotation and conventional flotation. The oversize is ideally suited to heap leach, with a lower than average grade due to the response factor in screening, and a low fines content to increase heap permeability, and a heap leach feed in which the values are exposed either on the surface of the remaining rocks, or accessible through the cracks formed during microwave treatment.

Whilst not limited, this configuration is particularly attractive for coarse grained ores which exhibit a very high natural deportment which can be further enhanced by microwaves.

FIG. 6 illustrates a fourth embodiment of the invention designed to microwave only the sand which has not achieved sufficient exposure during normal comminution, to have been recovered by coarse particle flotation. This process makes use of coarse particle flotation (CPF) and conventional flotation.

Coarse flotation may take place using a fit for purpose flotation machine such as the Eriez™ Hydrofloat. The Eriez Hydrofloat™, carries out the concentration process based on a combination of fluidization and flotation using fluidization water which has been aerated with micro-bubbles of air. The flotation is carried out using a suitable activator and collector concentrations and residence time, for the particular mineral to be floated. At this size, the ore is sufficiently ground to liberate most of the gangue and expose but not necessarily fully liberate the valuable mineral grains. The coarse flotation recoveries of partially exposed mineralisation is high, and the residual gangue forms a sand which does not warrant further comminution and conventional flotation.

In a conventional froth flotation process, particle sizes are typically less than 0.1 mm (100 μm). The ore particles are mixed with water to form a slurry and the desired mineral is rendered hydrophobic by the addition of a surfactant or collector chemical. The particular chemical depends on the nature of the mineral to be recovered. This slurry of hydrophobic particles and hydrophilic particles is then introduced to tanks known as flotation cells that are aerated to produce bubbles. The hydrophobic particles attach to the air bubbles, which rise to the surface, forming a froth. The froth is removed from the cell, producing a concentrate of the target mineral. Frothing agents, known as frothers, may be introduced to the slurry to promote the formation of a stable froth on top of the flotation cell. The minerals that do not float into the froth are referred to as the flotation tailings or flotation tails. These tailings may also be subjected to further stages of flotation to recover the valuable particles that did not float the first time. This is known as scavenging.

In a coarse flotation process (CPF) a fully liberated sulphide particle of up to say 2 mm diameter can be floated, whereas a particle with 5% sulphide surface exposure has a maximum flotation size limit of say 0.6 mm, and fully locked sulphides will not differentially float relative to gangue.

A particle size of below around 0.4 mm microns is typically required in most copper ores to ensure sufficient sulphide exposure for an almost quantitative recovery using CPF. Thus, after crushing the ore to a p80 size of a few mm, the ore less than 0.4 mm can be conventionally processed using CPF and flotation. Above 0.4 mm and up to 2 mm, some of the values with high surface exposure can be floated, but the sand residue still contains locked or marginally exposed sulphides, which did not break neatly along grain boundaries. This residue above say 0.4 mm, that has not broken along grain boundaries, can be drained, microwaved, and then lightly crushed to prepare the very coarse sand for scavenging using coarse flotation.

An example of the application of the invention in this embodiment, a high capacity HPGR 84 can readily reduce size of a Cu ore 86 containing 0.7% Cu to a p80 of say 2 mm. This ore is screened 88 at 2 mm to recycle the oversize ore 90 that is still too large for Cu recovery by CPF to the HPGR. The remaining ore less than 2 mm, is classified into three fractions. The first and highest Cu grade 92, at a size less than say 150 microns, is assigned to conventional flotation 94. The second fraction 96 up to 0.45 mm, also with elevated PGM content, is assigned to coarse particle flotation 98 with high recoveries. The residues from both conventional flotation 94 and CPF 98 are suitable for direct discard (regrind?). The third fraction 100 is too coarse for quantitative recovery of copper by CPF, but by adjusting CPF conditions in a very course CPF process 102, significant copper extraction can be achieved, leaving a residue 104 of around 0.3% Cu where the grade is still too high for direct discard mostly due to locked sulphides. This residue 104 can be treated by microwave 106, lightly comminuted 108 to break along the microfractures cause by the microwaves, and the now exposed sulphides can be recovered in a scavenger CPF 110.

Notable in this configuration is the minimal fine grinding required to achieve high copper recoveries.

Whilst not limited, this configuration is particularly attractive for fine-grained low-grade ores, where the natural low deportment response factor can be enhanced, to extend the range of quantitative coarse particle scavenging and avoiding excessive fine grinding.

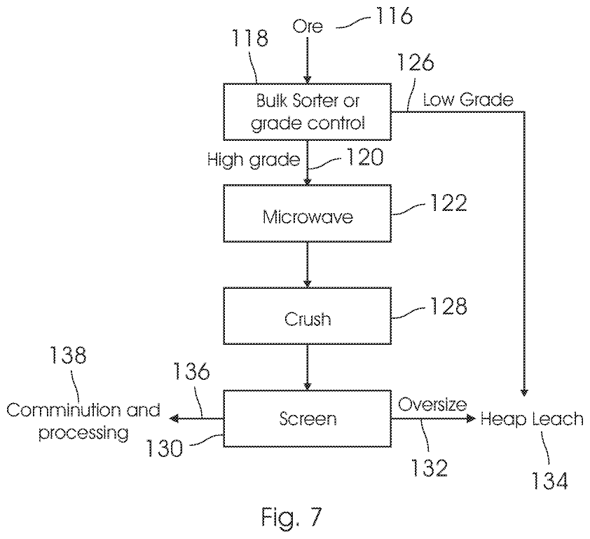

FIG. 7 illustrates a fifth embodiment of the invention designed to prepare the ore for heap leaching.

Heap leaching is often the preferred route for recovery of gold and copper from low grade ores, as heap leaching avoids much of the capital and energy cost of comminution and flotation or leaching. However, for high grade ores the higher extraction that is achievable after comminution, justifies this extra capital and energy. Many operations employ both techniques with ores being separated based on grade control techniques, and sometimes screening which takes advantage of the natural deportment of copper or gold to the fines.

In this fifth embodiment, the invention is applied to the high-grade fraction of the ore, to convert much of the high-grade fraction to a lower grade where heap leaching is the preferred processing route, with a very small high grade stream suited to conventional processing.

Ore 116 is separated by grade control or bulk sorting 118 for the pre-treatment of the high-grade fraction 120 by microwaves 122, and low grade fraction 124. After crushing 128 and screening 130 of this microwaved high-grade fraction, the oversize residue 132 is at a grade which is best suited to heap leaching 134 and assigned as such.

In addition to generating a suitable grade for heap leaching, the fines have been removed from this oversize residue by screening, making it more permeable for fluid transfer during heap leaching.

The enhanced high-grade fines 136 from screening 130 are ideally suited for further comminution and processing 138 through a very small flotation or agitation leaching facility, ensuring high recovery from this high grade fraction.

For some ore types, treatment by heap leaching offers a greater financial margin than that for recovery by flotation. In such a case a further variant to this 5th embodiment can be utilised. The screening subsequent to microwaving can be set to select only material that is already at a size suitable for coarse or conventional flotation such that further comminution is not required. The oversize 132 which contains the largest mass fraction of the ore, and has a higher proportion of its values exposed on the accessible surfaces of the ore as a consequence of the microwave processing, is then assigned to heap leaching 134. Through this configuration the very high grade fraction of ore is floated with high recovery, and most of the ore is heap leached with enhance heap leaching recoveries.

The low-grade stream 126 rejected from bulk sorting 118 can either be directed to heap leach 134, or further crushed and screened prior to heap leaching 134.

As an example of the application of the invention in this configuration, a heterogeneous gold ore with average grade of 0.6 gpt does not warrant fine grinding prior to leaching. Heap leach extraction of gold from the ore is around 60%. However, the average grade is made up of occasional zones of 1.5 gpt ore with most of the ore below 0.5 gpt. Through isolating the higher-grade ore, it can be processed through the invention to generate a small stream of fines containing around 2.5 gpt. This 2.5 gpt stream is best processed by conventional agitation leaching to achieve an extraction in excess of 90%. The remainder of the ore containing 0.5 gpt is heap leached with a 60% extraction. Overall gold recovery is enhanced relative to heap leaching all the ore.

Whilst not limited, this configuration is particularly attractive to low grade ores containing occasional high-grade veins. It is also suited to sites where the cost of conventional processing assets is particularly high.

### Other Configurations

In all the examples above, the product characteristics after microwaving and crushing offer products in which surface liberation occurs at coarser particle sizes.

Thus, any beneficiation technique which relies on surface exposure will operate effectively at coarser particle sizes. This size extension for subsequent beneficiation has a large impact on grinding energy, particularly for fine grained ores. This principle enables a coarser grind for the same recovery, and hence a greater fraction of coarse gangue to be removed during coarse flotation or sand heap leaching. As such the current invention is extremely complementary to both CPF and heap leaching as taught in U.S. Pat. No. 10,124,346; and US 20180369869.

As will be evident to those skilled in the art, the configurations used as examples of the current invention are not exclusive, and it is possible to assemble these six exemplar configurations in many different combinations. This includes combining or separating preselection techniques such as bulk sorting and screening. It also includes process operation at selected feed and product sizes which may vary considerably from one site to another.

The ultimate configuration for a particular site will be selected to balance the benefits; which include increased resource recovery, increased processing throughput, enhanced water efficiency, higher capital intensity, lower operating costs, and less tailings. The second factor affecting the selection of the ultimate configuration for a particular application is the ore mineralogy, affecting such factors as natural deportment response factor, ultimate grind size required for flotation, and leachability. And finally, the third factor for selection of the configuration is for brownfield applications is to complement pre-existing equipment types and throughput capacities.

As such there are many other configurations of preselection, microwaving, comminution and rejection of coarse gangue, all of which arise from the basic principle that underpins this invention, the ability to enhance the natural deportment of values to fine ore fractions, and hence to reject coarse gangue.

1. A process for recovering value metals from ore comprising rock, including the steps of:
i. preselection of a grade of ore to be microwaved to form an ore stream;
ii. subjecting the ore stream to microwave energy having a microwave power to partially fracture rocks in the stream and form a partially fractured ore stream;
iii. crushing the partially fractured ore stream with a crushing energy to preferentially fracture the pre-weakened ore, to form a crushed ore stream; and
iv. Screening the crushed ore stream through a screen having a size to form:
a fines fraction ore stream for further processing; and
a gangue fraction that may justify further processing.

2. The process claimed in claim 1, wherein preselection at step i is undertaken using bulk sorting to allocate a preferred range of ore grades from the ore to the ore stream to be microwaved.

3. The process claimed in claim 1, wherein preselection at step i is undertaken using screening to allocate a preferred range of ore sizes from the ore to the ore stream to be microwaved.

4. The process claimed in claim 1, wherein the preselection step i includes a Coarse Particle Flotation (CPF) step to allocate a coarse particle flotation residue with minimal surface exposure of values to the ore stream to be microwaved.

5. The process claimed in claim 1, wherein process parameters of microwave power, crushing energy and screen size are selected to produce a screen oversize gangue that is suited for direct disposal.

6. The process claimed in claim 1, wherein process parameters of microwave power, crushing energy and screen size are selected to produce a screen oversize gangue that is suited for heap leaching

7. The process claimed in claim 1, wherein process parameters of microwave power, crushing energy and screen size are selected to produce a screen oversize gangue that is suited for stockpiling and processing later in the mine life.

8. The process claimed in claim 1, in which a natural deportment response factor as measured at 50% mass retention, has been increased by more than 10%, more than 20% and more than 30%, relative to the response factor of the untreated ore.

9. The process claimed in claim 1, wherein the steps of preselection, microwaving, crushing and screening is carried out with ore without addition of water, to produce a dry gangue fraction at step iv.

10. The process claimed in claim 1, wherein the step of preselection selects more than one fraction for microwaving crushing and screening, and the process parameters for each step on each feed fraction are selected according to the feed grade.
